(19) United States
(12) Patent Application Publication
(10) Pub. No.: US 2019/0375229 A1
(43) Pub. Date: Dec. 12, 2019

(54) Organizational Notebook and Performance-Based Reward System and Method for Students

(71) Applicant: Frances Marie Ramos-Dones, San Juan, PR (US)

(72) Inventor: Frances Marie Ramos-Dones, San Juan, PR (US)

(21) Appl. No.: 16/381,669

(22) Filed: Apr. 11, 2019

Related U.S. Application Data
(63) Continuation of application No. 15/907,862, filed on Feb. 28, 2018, now abandoned.

(51) Int. Cl. B42F 21/00; B42D 15/00; B42D 5/04; B42F 7/06

(52) U.S. Cl. CPC B42F 21/00; B42D 15/0046; B42D 1/001; B42F 7/06; B42D 5/047

(57) ABSTRACT

A system of notebooks that are color-coded to relate to a particular class or subject. For example, a green notebook could relate to a computer class, a red notebook could relate to compounds' molecular structure, etc. The notebooks are fashioned to employ different calligraphy (first, second, third, quadrille 5 mm, 6 mm, 7 mm and regular lines). As presently contemplated, the notebooks will be available in different, bright colors. By way of illustration and not as a limitation, the constituents may be incorporated into a different color-coded product. The system further includes control articles such as an agenda to track student progress using indicia and give rewards to the student for achieving predetermined milestones.

### RELATED APPLICATIONS

The present application is a continuation-in-part of U.S. application Ser. No. 15/907,862 filed on Feb. 28, 2018, which is a continuation-in-part of U.S. application Ser. No. 13/165,843 filed on Jun. 22, 2011, which is a continuation in part of U.S. application Ser. No. 12/656,243 filed on Jan. 21, 2010.

### STATEMENT REGARDING FEDERALLY SPONSORED RESEARCH AND DEVELOPMENT

N/A

### BACKGROUND OF THE INVENTION

### Field of the Invention

The present invention is generally directed to organizational system and kit, and more particularly, to a group of articles linked to an organization unit for use in educational systems and institutions that enable students to organize and prioritize instructional materials, offering rewards to students as an incentive for good performance based on parameters determined by teachers.

### Discussion of the Background

Some health specialists recommend several organization tools in order to be more successful at work, assist people with brain or memory deficits, maximize academic experience and more. Students deserve the best academic experience that will enable them to build a better future. It is crucial to provide students—without distinction of their learning styles—with the tools that will help them maximize their potential.

Acquiring good study habits is essential to academic success. One aspect of acquiring such habits is that of organization. Students at the elementary level and those suffering from different variations of attention deficit disorder (ADD) usually lack organizational skills. This lack of organization translates into disarray in their lockers, desks, notebooks, etc. Often, the student brings the wrong notebook home or to a particular class, further exacerbating the learning process. Most experts agree that organizational skills are learned rather than inherited. It is also agreed that the earlier these skills are learned and developed the better the student's chances for success (not only in an academic environment but also in life).

Psychologists and child/teenager specialists strongly advocate the use of color, as a form of indicia to be used as a medium to raise a child's or teenager's attention level. Heretofore, teachers and parents, especially in the elementary grades, have utilized various methods (stickers, numbers, color markers, etc.) to mark and differentiate notebooks for organizational purposes. Since everyone uses a different method, there is no continuity and the mélange causes more confusion for the students. The education sector would certainly welcome a uniform system for identifying notebooks to enhance students' organizational abilities.

Positive reinforcement is also important for developing organizational skills in students. Establishing goals and rewarding students during the process of reaching those goals encourages them to keep doing what they do right and to stop doing what they do wrong. When students only get punished for improper behavior and not rewarded when their behavior improves, they lack motivation to keep improving. Teachers may notice particular behaviors in specific students that require specific goals and rewards in order to successfully develop the appropriate responsibility and organization skills.

Thus, student organizational notebook systems solving the aforementioned problems are desired.

### SUMMARY OF THE INVENTION

The present invention is generally related to an organizational system and kit comprising organization control article such as an agenda or a poster, and several course articles linked to said organization control article, wherein said course articles comprise notebooks, file folders, envelopes, book labels, index cards, planners, notebook paper, page-marker flags, and binders with indicia, such as color-coded, in order to relate to a particular academic class or subject with said control article. For example, a green notebook could relate to a computer class, a light green notebook could relate to a computer laboratory, a yellow notebook could relate to a science class, a red notebook could relate to a compound's molecular structure, etc. The present invention further comprises reward planning items, such as reward schedules and marker stickers for keeping track of a student's progress towards a behavior goal.

In a first aspect of the present invention, the notebooks for right handed or left handed are fashioned to employ different calligraphy such as first, second, third, quadrille, 5 mm, 6 mm, 7 mm, 9 mm, and regular lines, among others.

Another aspect of the present invention is that, as presently contemplated, each notebook will be available in different distinctive indicia, such as bright colors, with matching double-pocket folders for homework, an agenda and the like. Accordingly, the invention provides a system for assisting students to organize and thereby creating a better atmosphere for learning. Each notebook also includes a section for establishing, scheduling, and marking rewards so students and teachers may keep track of how well the student is doing and when a goal is reached.

Another aspect of the present invention is that said invention provides for improved course articles such as binders, folders, envelopes, book labels, index cards, page-marker flags, notebook paper, and reward-marker stickers, thereof in an arrangement for the purposes described that are inexpensive, dependable and fully effective in accomplishing their intended purposes.

Another aspect of the present invention is to provide a control article, such as an agenda or poster, wherein said control article comprises means to identify indicia with a particular subject matter, means to summarize and show long term tasks, means to prioritize tasks, means to track conduct behaviors, means to track time to perform a task and/or homework, means to illustrate a completed the task, means to establish goals, means to keep track of the progress towards a goal, and means of establishing rewards for accomplishing goals.

Another aspect of the present invention is to provide a control article, wherein said control article comprises means to identify the material need to complete a particular task of a particular subject matter.

Another aspect of the present invention is to provide a control article, wherein said control article comprises means to classify, encourage and provide a reward for user performance after the user completes a task related to a particular subject matter. The present disclosure provides for the use of a sticker with different indicia directed to the performance of the user. The stickers are divided by groups and each group represents a particular performance and is distinct from other groups in order to make easier the classification of user performance.

Another aspect of the present invention is to provide a poster related to the control article or agenda, wherein said poster provides a visual aid to educators, parents and/or the user in order to provide a reminder of pending tasks or to show completed tasks. The calendar comprises structure related aspects to the agenda in order to easily relate subject matters and materials with the tasks. The calendar is made bigger than the control article and is intended to be located at a location in such way an educator/parent visualize easier the task of the user/student. Indicators and spaces in the poster are to be completed by the teacher or parent depending on the specific tasks and goals towards which the student has to work.

The disclosure itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings, which are incorporated herein, constitute part of the specifications and illustrate the preferred embodiment of the invention.

FIG. 1 shows the organizational system and kit including an organization control article and several course articles.

FIG. 2 is an environmental, perspective view of a student using the organizational system and kit according of the present invention.

FIG. 3 is a perspective view of notebooks according to the present invention. Similar reference characters denote corresponding features consistently throughout the attached drawings.

FIG. 3A shows a sticker sheet and a reward tracking section with indicia for marking milestones achieved by a student the received rewards.

FIG. 4 represents the backpack filled with the articles of the organizational system and kit.

FIGS. 5A and 5B show a perspective view of the organizational system and kit's matching file folders, wherein said folders can be grouped by a binder ring.

FIG. 6 is a perspective view of the organization control article wherein said control article is organized to present each particular indicia, such as color codes, matching to the corresponding course articles.

FIG. 7 is perspective view of the left page of the organization control article wherein said control article is organized into subsections, color codes, matching to the corresponding course articles.

FIG. 8 is a perspective view of the right page of the organization control article wherein said control article is organized into color codes, matching to the corresponding course articles.

FIG. 9 is a demonstration of some of the organizational system and kit's constituents grouped together by matching colors.

FIG. 10 is a perspective view of the organizational system and kit's color-coded index cards.

FIG. 11 is a perspective view of the organizational system and kit's color-coded notebook pages.

FIG. 12 is a perspective view of the organizational system and kit's color-coded plastic envelopes.

FIG. 13 is a perspective view of the organizational system and kit's color-coded book labels.

FIG. 14 is a perspective view of the organizational system and kit's color-coded page-marker flags.

FIG. 15 is a perspective view of the organizational system and kit's color-coded ring binder.

FIG. 16 shows the left page of another embodiment of the organization control article wherein said page includes a behavior identifier that comprises a reward.

FIG. 17 shows the right page of another embodiment of the organization control article wherein said page includes a behavior identifier that comprises a reward.

FIG. 18 shows the left page of another embodiment of the organization control article wherein said page includes at least one section with a material task identifier.

FIG. 19 shows the right page of another embodiment of the organization control article wherein said page includes at least one section with a material task identifier.

FIG. 20 shows the left page of another embodiment of the organization control article.

FIG. 21 shows the left page of another embodiment of the organization control article.

FIG. 22 shows reward elements that may be used in combination with the organization control article.

FIG. 23 shows a poster calendar associated with the organization control article.

### DESCRIPTION OF THE PREFERRED EMBODIMENT

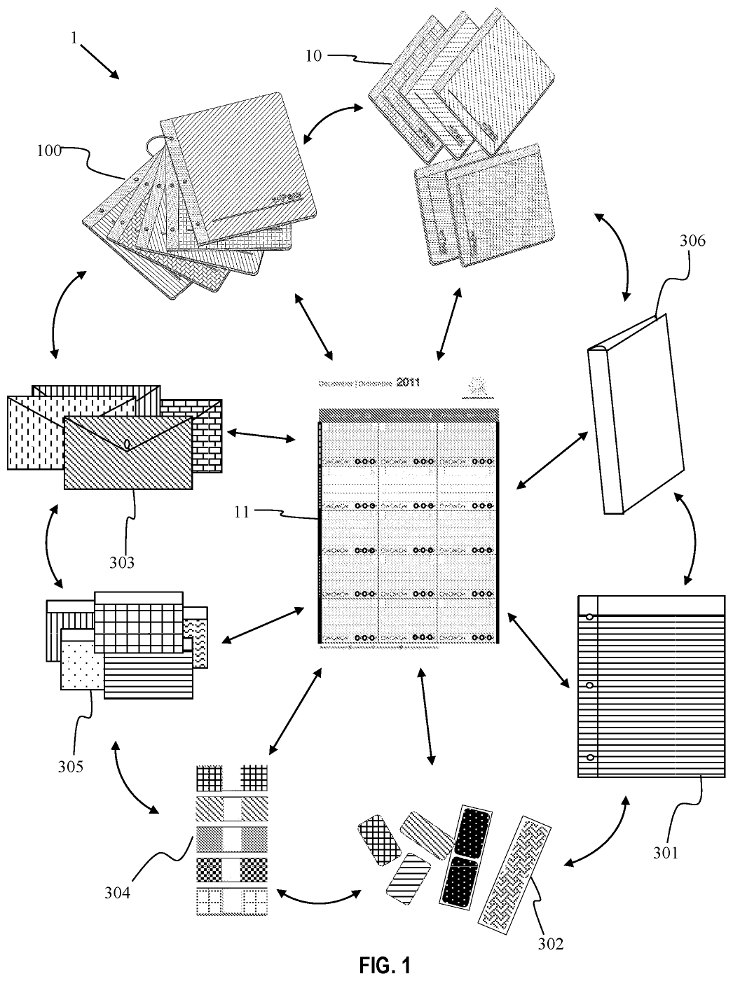

FIG. 1 discloses an organizational system and kit comprising an organization control article 11, such as an agenda, weekly planner or the like, and several school course articles or supplies 10, 100, 301, 302, 303, 304, 305, 306, linked to said organization control article 11 by means of indicia. The course articles comprise notebooks 10, file folders 100, envelopes 303, book labels 302, index cards 305, notebook paper 301, page-marker flags 304 and binders 306 with indicia. The indicia assist with the identification of articles by distinguishing the same type of article from each other. For example, a first notebook and second notebook having structure similarities are distinguished from each other by comprising a first indicia (such as color) and a second indicia respectively, wherein first indicia is different from the second indicia.

Further the indicia of an article can be related to a different article having a different structure but the same indicia. Having different course articles with the same indicia assists the creation of groups under particular indicia. Each particular indicia could represent a particular subject matter, academic class, a case, etc. The course articles 10, 100, 301, 302, 303, 304, 305, 306 having the same indicia are further related to the organization control article 11. Each article is described in more detail below.

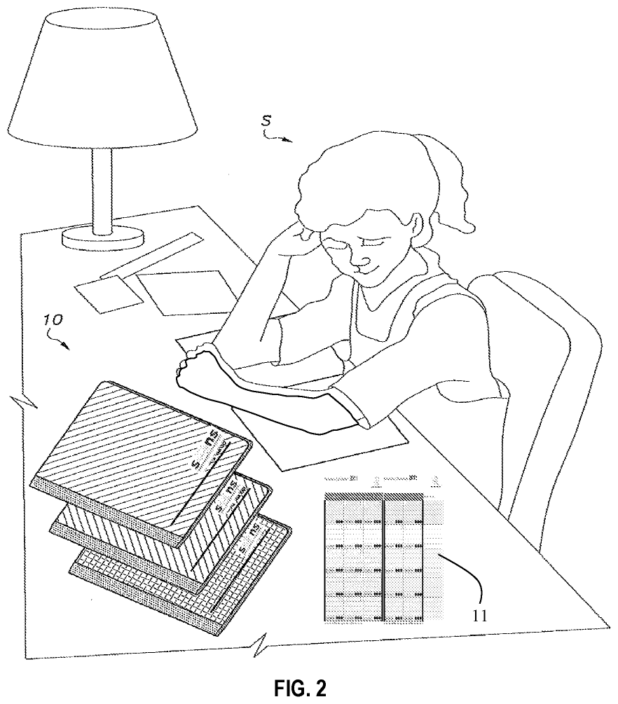

FIG. 2 is directed to a person, such as a student, using the organizational kit 1, including notebooks 10 and control article 11.

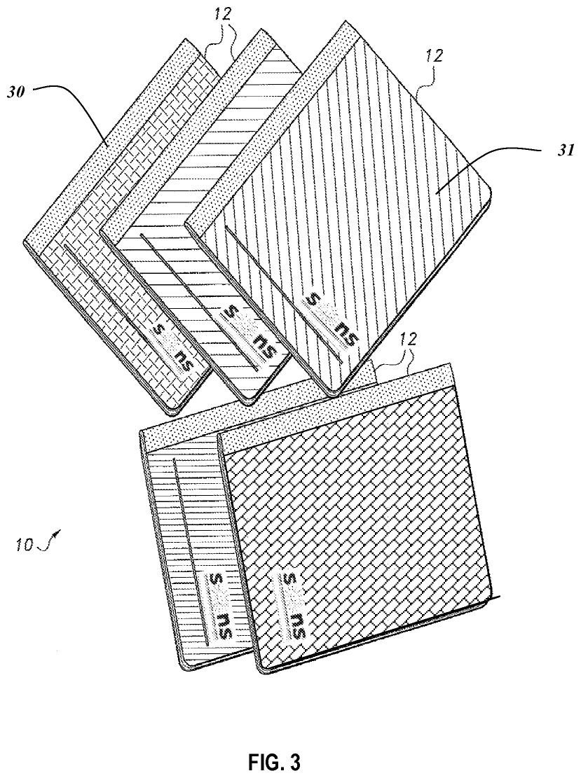

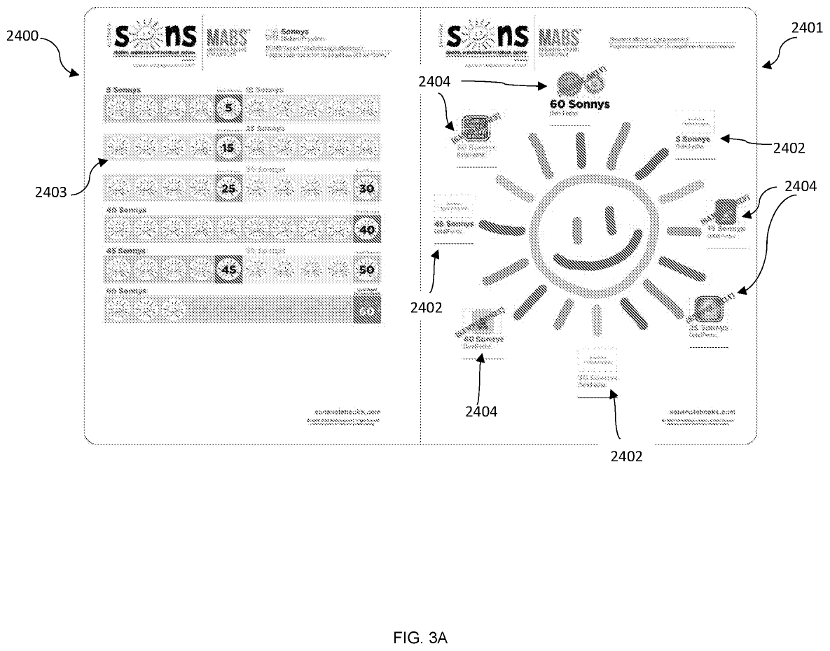

Particularly, FIG. 3 is a perspective view of student's organizational notebooks 10 according to the present invention. Each notebook 12 forms a system comprising multiple notebooks 10. Each notebook 12 comprises a distinctive indicia, such as different color or texture, and each color represents a particular subject, as determined by the student, teacher or parent. Each notebook spine 30 could have the same indicia for all the notebooks or it could have uniform indicia, such as the same color as the notebook's cover 31 to provide easy identification of academic class or subject when it is placed inside a container T. This arrangement creates less confusion for the student. The student is more likely to associate a color with a particular class, thereby organizing school work by subject matter. Although five notebooks are shown, it should be recognized that the number of notebooks utilized would correspond to the number of classes taken by the student.

As shown in FIG. 3A, each notebook and folder contains a sticker sheet 2400 that are used as reward indicia for appropriate academic behavior towards a goal and reward, and in its inside cover, a reward tracking section 2401 that contains milestone and reward indicia wherein students, parents and/or teachers can determine how far into a goal or milestone, and therefore close to receiving a reward, the student is. In order for the reward section to properly function, the student should not have access to the sticker sheet 2400. The teacher or parent will determine, based on each student's specific situation, if a milestone marker, such as a sticker 2403 should be awarded and placed in his notebook. In an exemplary embodiment, the reward section comprises milestone indicia 2402 where stickers 2403 can be placed when a student achieves a specific milestone, based on the teacher or parent's determination of what the performance of the student was. For example, every time the student participates in class, a sticker 2403 will be awarded. As another example, every time a student participates in class and answers a question correctly, a sticker 2403 will be awarded. The teacher or parent will determine what entitles the student to a sticker and how many stickers are required for getting a reward. This determination is made depending on each student's abilities, personality and limitations. When the student reaches the amount of stickers 2403 required for the reward, a reward sticker will be placed on the reward indicia 2404 of the notebook, encouraging the student to want to keep earning stickers in order to earn more rewards. Rewards are also determined by the parent or teacher based on the student's abilities, personality and limitations. Examples of possible rewards are not having to use the school uniform for a day, eating candy in class, choosing a movie to watch in class, and other small privileges that show the student that improving his behavior leads to benefits. In another exemplary embodiment of the present invention, rewards can be bigger every time or unknown, making the student work towards the goal because he wants to find out what the reward is, or he at least knows it will be even better than the previous reward.

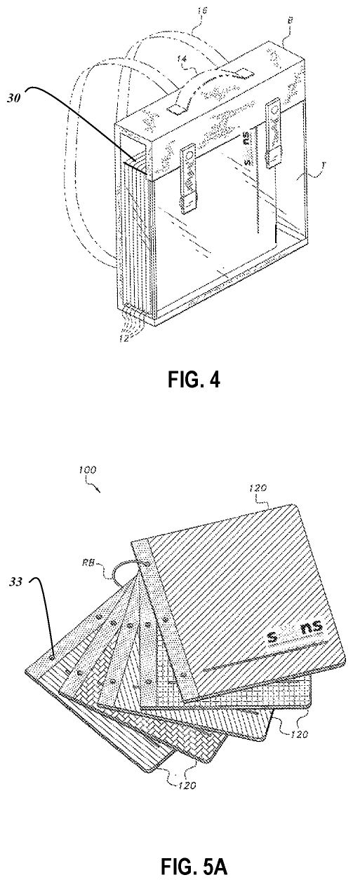

FIG. 4 represents a backpack or container T filled with the student's organizational notebooks 10. The notebooks 10 are placed with their spine 30 up to provide easy identification of academic class or subject. This allows the student to save time searching for the right notebook, thus improving his or her performance.

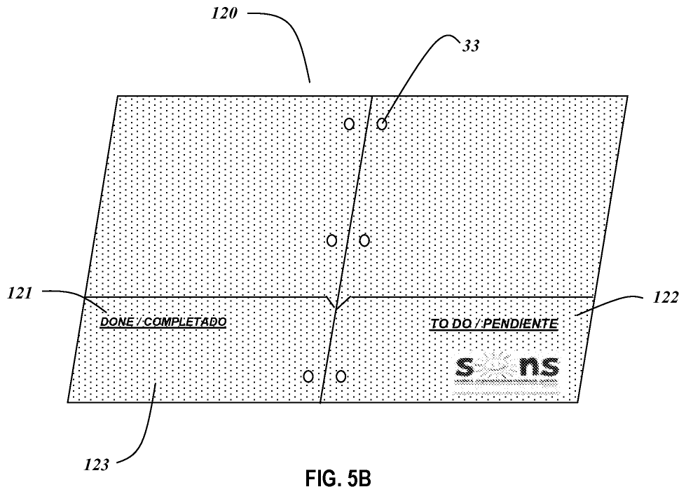

FIG. 5A is a perspective view of the organizational system and kit matching file folders 100, wherein said folders 100 can be grouped by a binder ring RB. Each folder 120 is marked or comprises indicia, such as color coded with all the constituents of the present invention. The folders 100 can be easily ungrouped if a professor needs to keep it to grade school work.

FIG. 5B is a perspective view of the organizational system and kit matching file folder 120. Said folder 120 has interior pockets 123, wherein the right pocked is labeled “To Do” 122 and the left pocked is labeled “Done” 121. The structure of the folder 120 allows the student to easily structure and organize his tasks. Based on the student's determination of which tasks are complete and which ones are still pending, the student may place the documents related to each task in the properly labeled pocket.

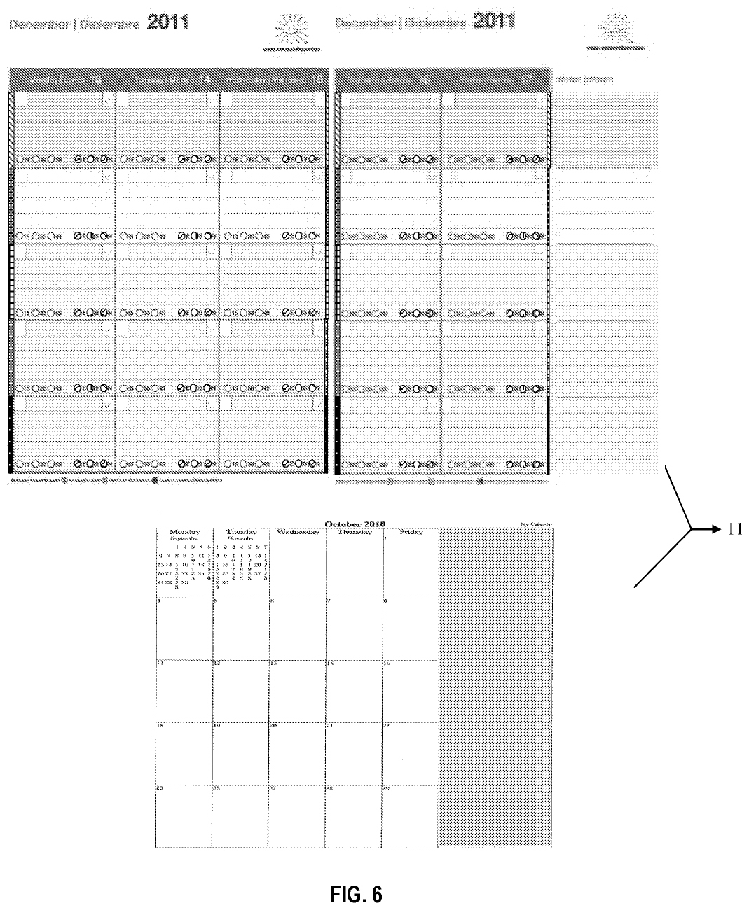

FIG. 6 is a perspective view of the organization control article 11, for example an agenda, wherein such agenda comprises a plurality of color-coded pages corresponding to an academic class or subject. A determination made by the parent, teacher or student is made as to which color corresponds to each class or subject.

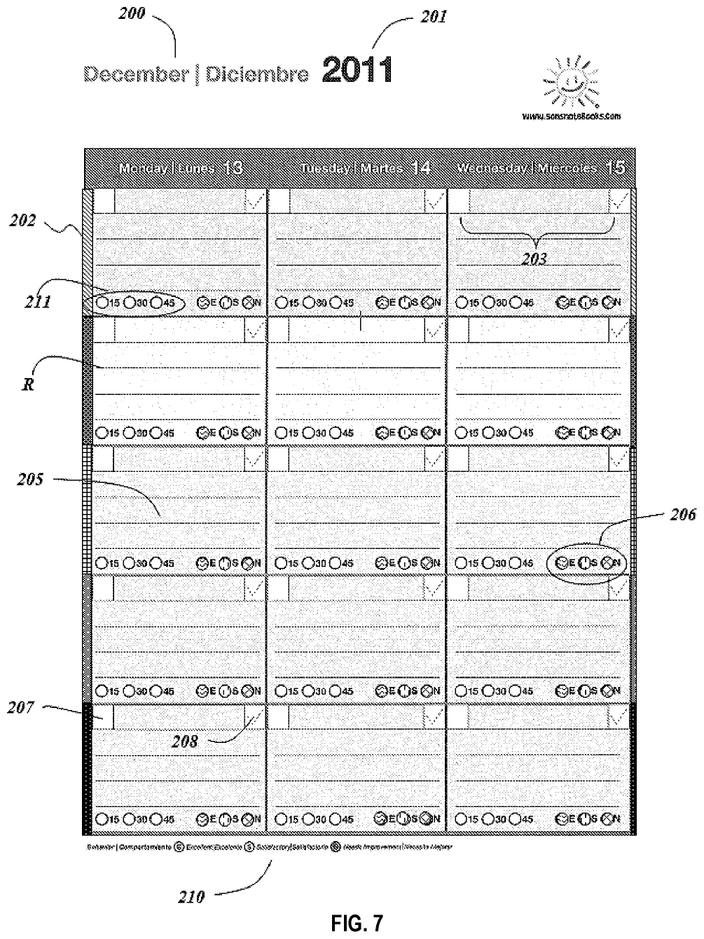

FIG. 7 is a perspective view of left page of the organization control article 11 dated within the current academic year 200, 201, wherein said page is organized into color codes 202, matching to the corresponding academic class or subject. The organization control article 11 may or may not have printed classes or subjects. Preferably the only academic class or subject identification method is by colors, which promotes the student to develop and improve memorization skills. One of the constituents of the organization control article 11 are two small boxes 203 located at the top corners of the specific day and class box 205 in order to promote organizational skills. The priority of each task will be determined by the teacher and the parents of the students, taking into account the student's needs. The student may also on its own establish task priorities. After the priority of each task is determined, they are recorded into the control article by writing in the left box 207 a number from one to five (1-5), wherein number one will be the highest priority level and number five will be the lowest priority level. The priority task identifier 207 can be written by the user or it may come pre-written in the box to allow the user to mark/select the priority number; always keeping in mind that the lowest number is the highest priority level. The order of priorities assigned allows for the student to better allot time for each task and to have a visual representation of how much work is necessary to complete all of the day's assignments. Further, a task completion identifier is provided. In the instant case the task completion identifier is a check box. For example, the student will check the right box 208 when he or she has completed the task.

Parents and teachers are also to make a determination as to a student's behavior during a specific period of time. The bottom left corner of the class box 205 provides a behavior section 206 with behavior identifiers wherein the parent, guardian or teacher may write a classification about the student's behavior 210, which is provided at the bottom of the page. The behavior classification system 210 may consist of letters “E”, “S”, and “N”, which stand for “excellent”, “satisfactory” and “needs improvement” respectively. This section informs anyone reading the control article what the behavior of the student is during that class, so the reader (parents or other teachers) can compare with the behavior of the student in other classes with the same teacher or at the same time period. This allows for finding factors that affect the student's behavior, and organizing and adjusting the teacher's/parent's methods to improve the student's behavior.

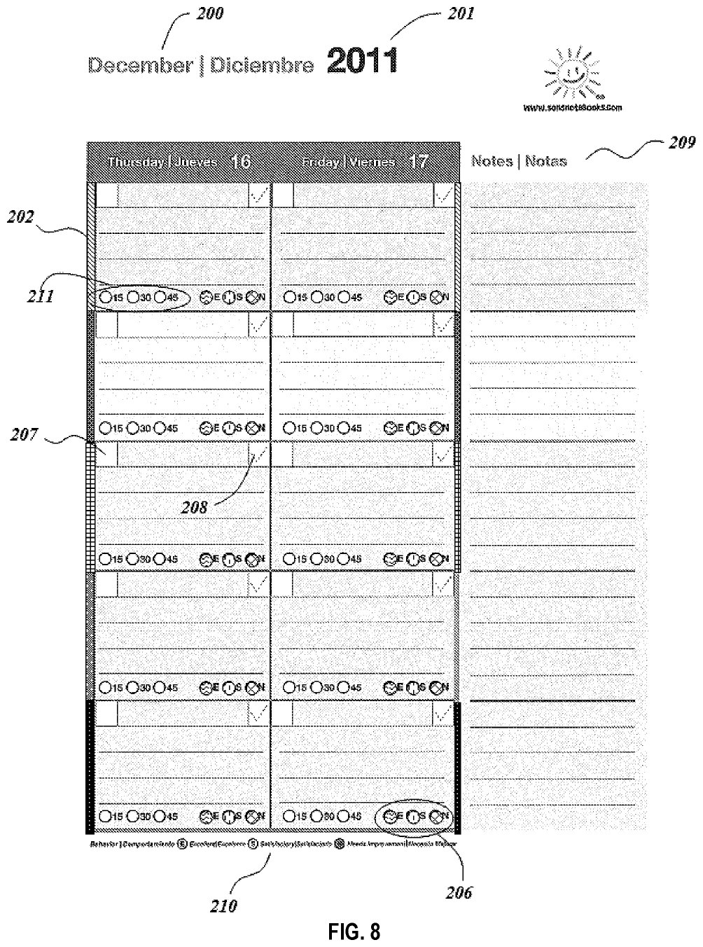

FIG. 8 is a perspective view of right page of the student organizational notebook system's agenda 11 dated within the current academic year 200, 201, wherein said page is organized into color codes 202, matching to the corresponding academic class or subject. The right page provides a space for notes 209 where the student, professor or parent may write important matters.

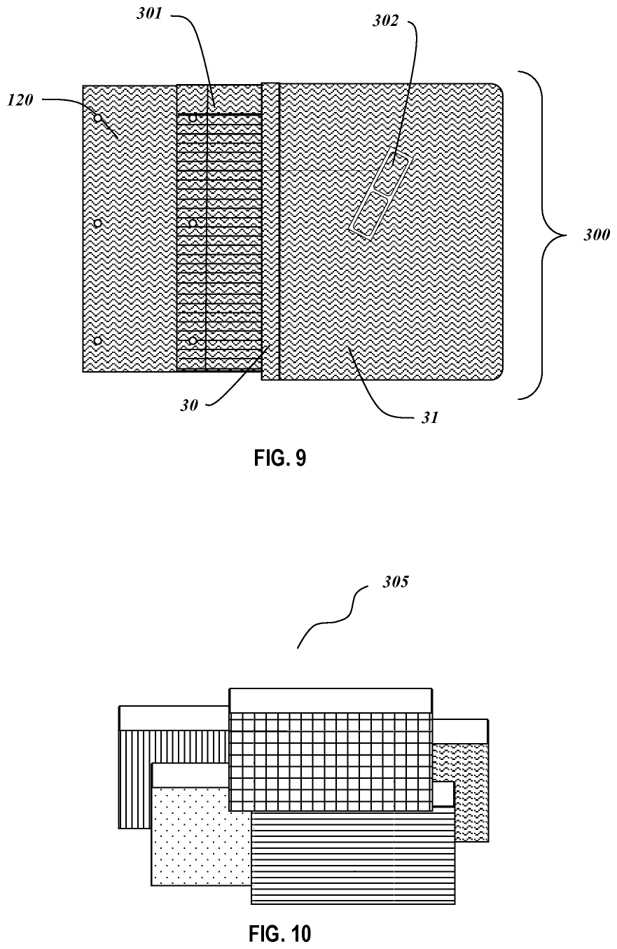

FIG. 9 is a demonstration of some of the student's organizational notebook system's constituents grouped together by matching colors 300, wherein grouped constituents, as a matter of example, consist of a file folder 120, notebook paper 301, book label 302, and notebook 31. The aforementioned constituents are of the same color to help the student improve organizational, memorization and planning skills.

FIG. 10 is a perspective of the organizational system and kit's color-coded index cards 305, wherein said cards 305 are matched to their corresponding academic class or subject, allowing the student to improve memorization skills and quick learning.

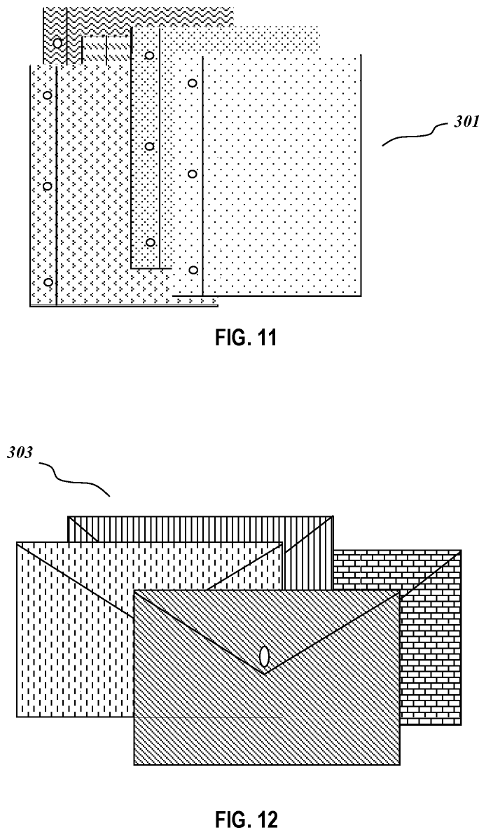

FIG. 11 is a perspective of the organizational system and kit's color-coded notebook papers 301, wherein said notebook papers 301 are matched to their corresponding academic class or subject. In the case a professor needs to grade school work, the student may remove notebook papers 301 from organizational system and kit ring binder 306 or any other container and place it on the student's organizational notebook system's corresponding color-coded plastic envelope 303 or file folder 120 and hand it out to the teacher.

FIG. 12 is a perspective of the organizational system and kit's color-coded plastic envelopes 303, wherein said plastic envelopes 303 are matched to their corresponding academic class or subject. The student may use the plastic envelope place important class documents. Additionally, said plastic envelopes 303 may be used to save material that will not be used, graded school work that may be used as study material for exams, projects or as future reference. To improve organizational skills, items placed in the file folders 120 will then be transferred to the plastic envelopes 303.

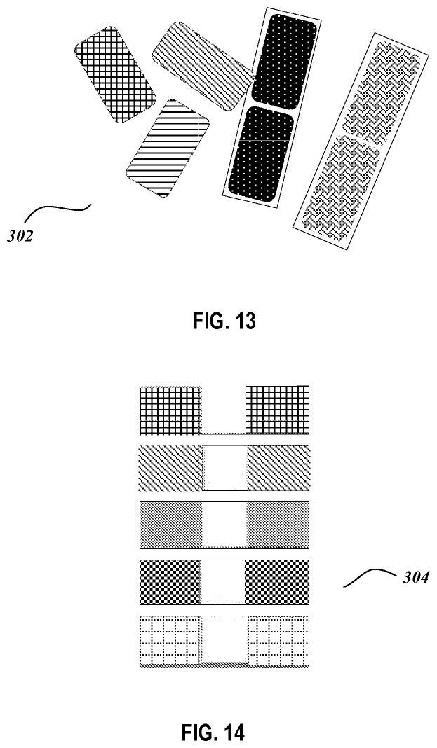

FIG. 13 is a perspective of the organizational system and kit's color-coded book labels 302, wherein said book labels 302 are matched to their corresponding academic class or subject. The color-coded book labels may be placed on the corresponding academic class or subject textbook's spine or workbooks, among other school materials. Labeling textbooks or other school material helps the student improve his or her organizational skills especially because when the student has an assignment, he or she will take everything that is labeled the same color.

FIG. 14 is a perspective of the organizational system and kit's color-coded page-marker flags 304, wherein said page-marker flags 304 are matched to their corresponding academic class or subject. The student may mark, flag or highlight important information. Color coded page-markers 304 are easy to spot and easy to write on and they stick securely and remove cleanly for no document damage.

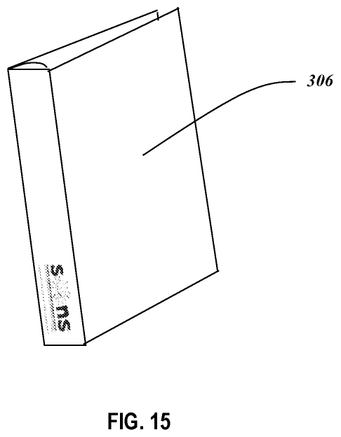

FIG. 15 is a perspective of the organizational system and kit's color-coded ring binder 306, wherein said color coded ring binder 306 is matched to its corresponding academic class or subject. The ring binder 306 may hold its corresponding color-coded notebook paper 301 by means of clamps running through the holes of the notebook paper 301. The binder may also hold its corresponding color-coded file folder 120, making it easy and convenient for the student to transfer notebook paper 301 from the ring binder 306 to the matching file folder 120, thus, improving organizational skills.

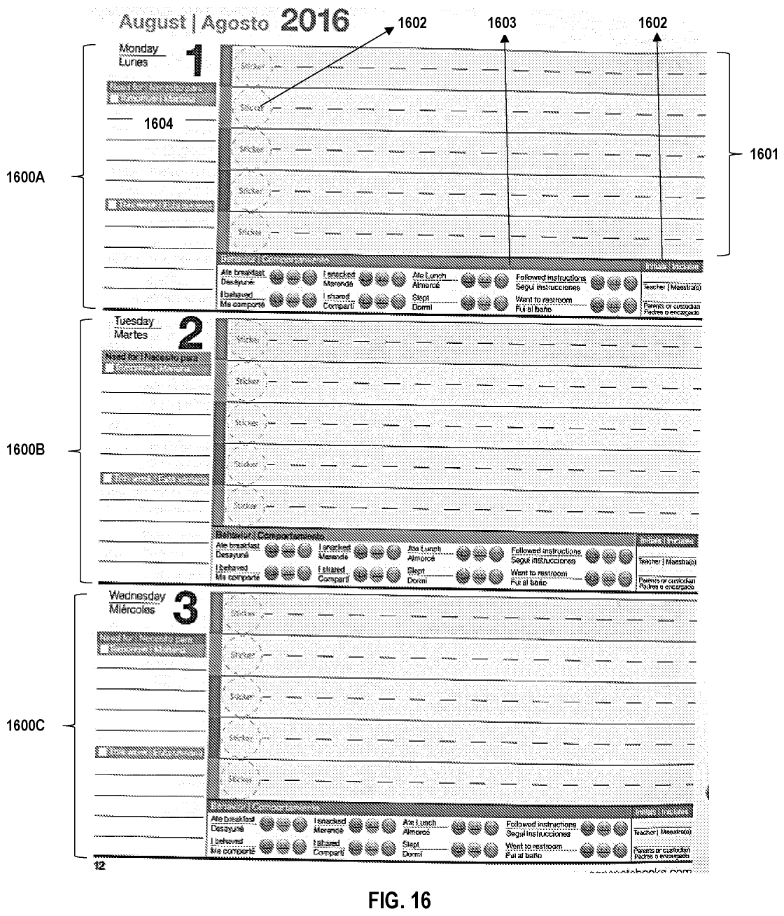

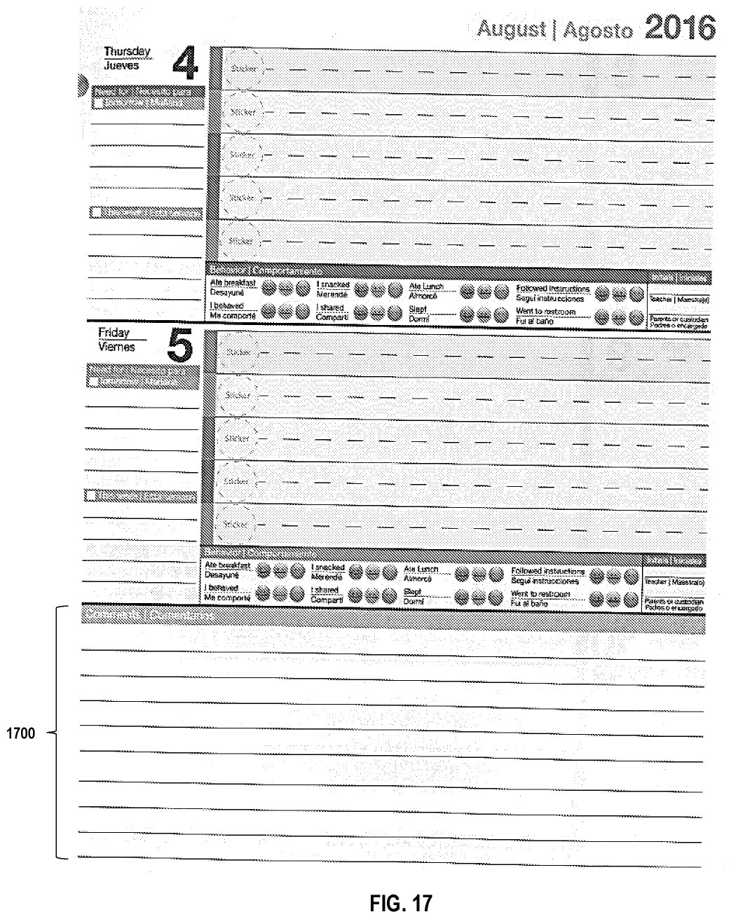

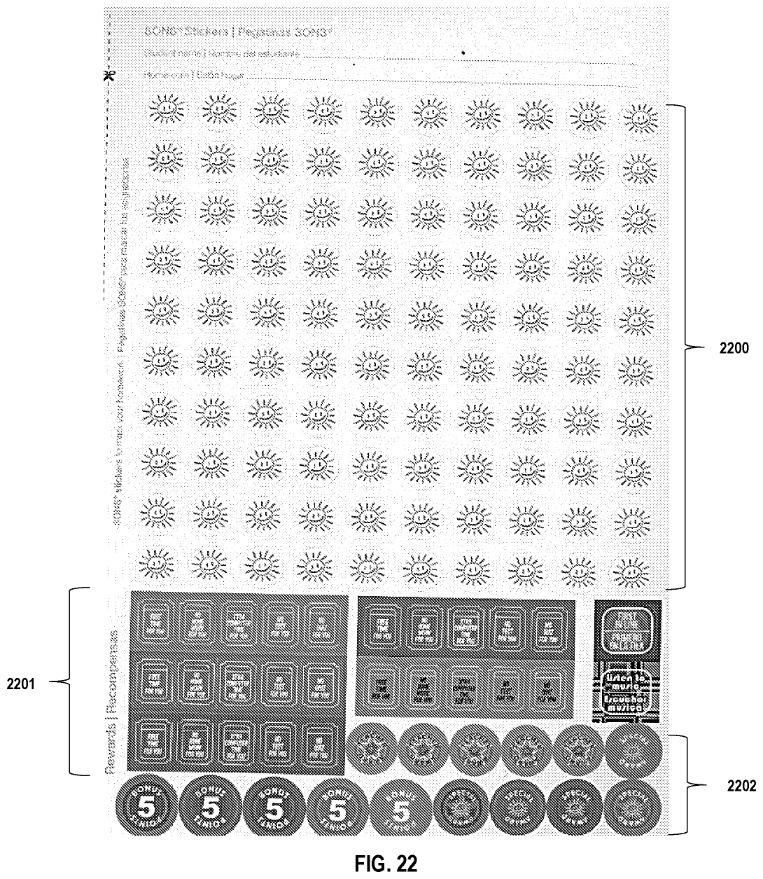

FIG. 16 shows the left page of another embodiment of the organization control article 11 wherein said page comprises a plurality of sections 1600A, 1600B, 1600C, each section corresponding to a particular school day and each section is further subdivided into one or more subsections wherein at least a first subsection 1601 comprises color-coded rows for writing down assignments, each color-coded row corresponding to an academic subject, and each color-coded row comprising an area for placing a reward element 1602, such as an adhesive element or sticker, for rewarding good behavior of the student or for incentivizing the student to complete an assignment related to the particular subject; at least a second subsection 1603 comprises a behavior indicator that indicates or keeps track of certain student behaviors during the school day, such as whether the student had breakfast, behaved, had a snack, engaged in sharing, had lunch, slept, followed instructions or went to the restroom during the school day; at least a third subsection 1604 comprises an area for including daily and/or weekly student needs; and at least a fourth subsection 1605 comprises an area for providing parent/custodian and/or teacher initials. It should be noted that the color-coded rows perform the function of associating a color with a particular academic subject. As such, every time a student sees a particular color on the organization control article 11, it will associate said color with a particular academic subject. It should further be noted that the organization control article 11 may also include a page comprising a plurality of reward elements or stickers as shown in FIG. 22 that are separated into one or more groups 2200, 2201, 2202, each group of reward elements comprising indicia that is different than the indicia in the other groups of reward elements and wherein each reward element or sticker represents a reward or incentive for completing a task or assignment related to a particular subject. As such, the reward elements perform the function of rewarding or incentivizing the good behavior of the students. Said rewards may be determined by parents or teachers depending on a student's needs, abilities and personality. Since the rewards section comprises spaces for rewards stickers, it allows for an evaluation of the student's improvement or decline. For example, an empty rewards section may mean the student does not care for the rewards offered or that he has difficulty reaching the necessary goals. This visual representation of a student's tendencies allows teacher and parents to adjust their methods accordingly. Lastly, FIG. 17 shows the right page of the embodiment shown on FIG. 16, wherein at least one of the plurality of sections comprises a ruled or blank area for providing comments 1700.

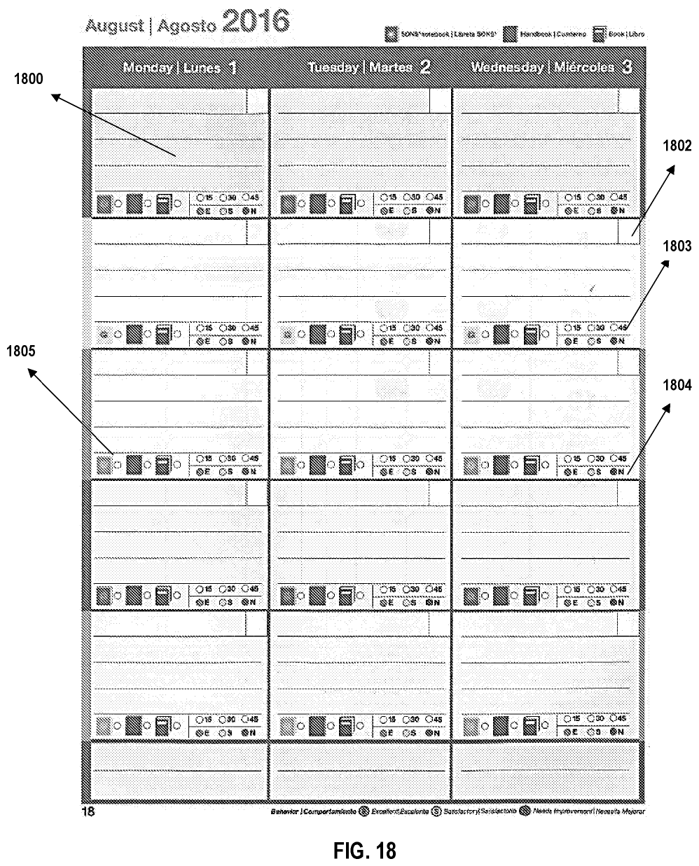

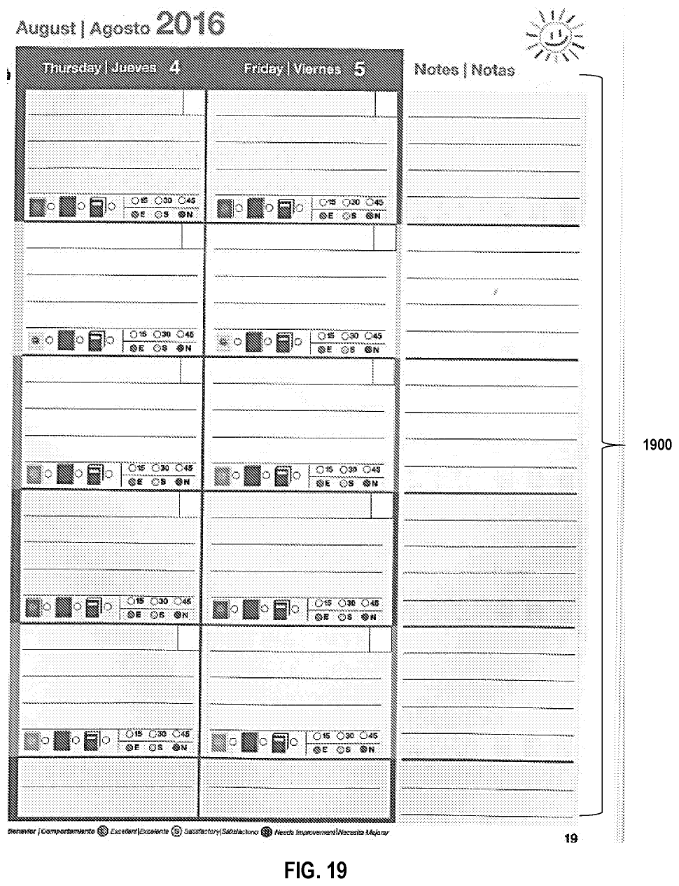

FIG. 18 shows the left page of another embodiment of the organization control article 11. In particular, the page of the organization control article 11 comprises a plurality of rows and columns, wherein each column corresponds to a particular school day and each row is color-coded and corresponds to a particular subject. As such, each subject is consistently associated with a particular color throughout the pages of the organization control article 11. Furthermore, the point at which a row and column intersect with each other forms an intersection area 1800 that represents the specific school day allotted or dedicated to a particular subject. Additionally, for each different school day, the intersection area 1800 further comprises a box 1802 for marking the priority of an assignment for a particular subject as previously explained with respect to FIG. 7. Moreover, the intersection area 1800 further comprises a section for selecting or providing a time estimate 1803, in which the student or teacher estimates the time required to complete an assignment. For example, the student or teacher can estimate whether the assignment will take between 15, 30 or 45 minutes to complete. Furthermore, for each school day, the intersection area 1800 further comprises a section with behavior identifiers 1804 which are used to classify a student's behavior. For example, the behavior identifiers may be the letters “E”, “S”, and “N”, which correspond to behavior that is either “Excellent”, “Satisfactory”, or “Needing Improvement” respectively, as discussed with respect to FIG. 7. The student may use said behavior identifiers as a visual aid in planning to reach goals and receive rewards. For example, if the student notices a specific teacher often considers his behavior “needing improvement” and it is affecting his ability to reach a goal and receive a reward, he may be encouraged to change his behavior in order to receive a better evaluation. Students may also want to compare their control articles and encourage each other to improve. Lastly, for each school day, the intersection area 1800 further comprises at least one section having at least one material task identifier 1805 that allows the user to identify the text or materials required to complete that particular school day's assignment, wherein the material task identifier includes, but is not limited to, indicia representing a book, a handbook or a notebook that may be required to complete that school day's assignment. Thus, the indicia helps in quickly identifying the text or materials needed to complete a particular subject's assignment and serves as a reminder of the materials needed to complete the assignment. In other embodiments, said indicia allows the student to know what the assigned task is. For example, indicia representing a book indicates that the assignment is reading a chapter; indicia representing a workbook indicates that the assignment involves practice exercises. This gives the student a visual representation of what the pending work entails, so he can organize his time accordingly. This also helps parents and teachers understand if a student is being assigned to do similar tasks too often and the effect, if any, that it has on the student's performance. It should be noted that each intersection area 1800 shown in FIG. 18 is in the shape of a square, but it may be designed in any other shape. FIG. 19 shows the right page of the embodiment shown on FIG. 18, wherein one of the columns compromises a ruled or blank area for providing notes for each particular subject 1900.

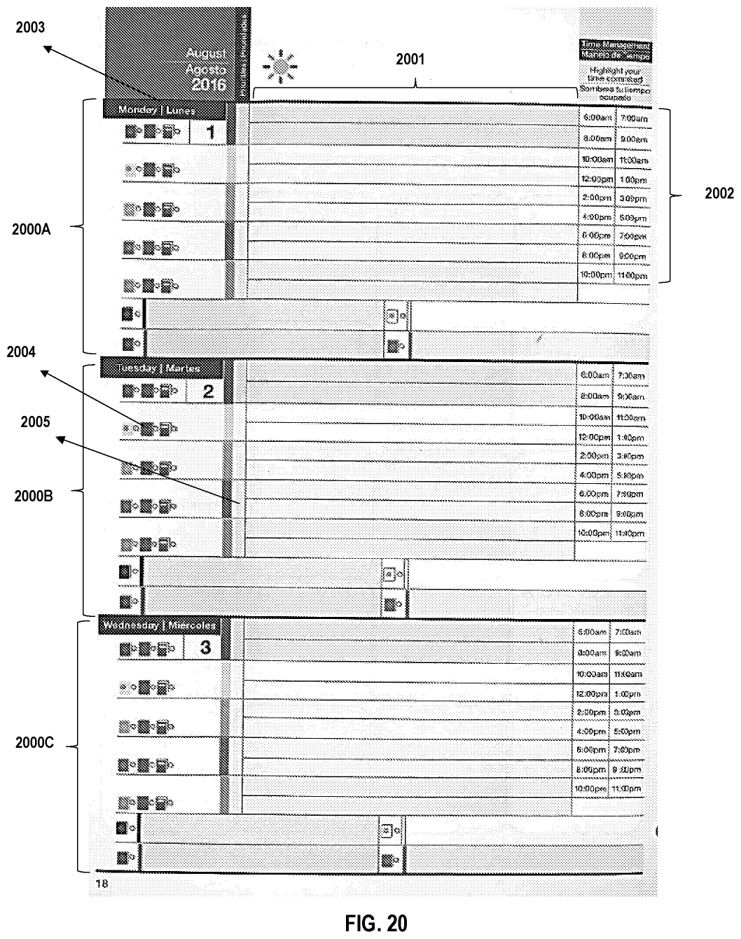

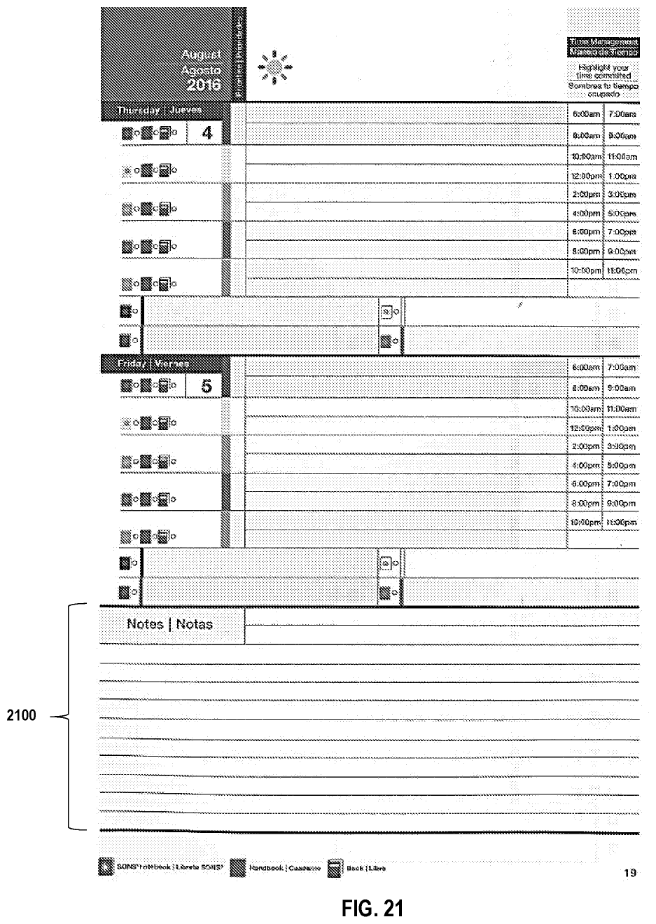

FIG. 20 shows the left page of another embodiment of the organization control article 11 wherein said page comprises a plurality of sections 2000A, 2000B, 2000C each section corresponding to a particular school day and each section further subdivided into one or more subsections wherein at least a first subsection 2001 comprises color-coded rows corresponding to an academic subject, said rows comprising at least one area 2005 for providing an order of priority of a particular subject, wherein the first row corresponds to the subject of highest priority and the last row corresponds to the academic subject of lowest priority; at least a second subsection 2002 comprises a time management area for indicating the time committed to a particular subject; and at least a third subsection 2003 comprises an area that includes at least one material task identifier 2004 that allows the user to identify the text or materials required to complete that particular school day's assignment, wherein the material task identifier includes, but is not limited to, indicia representing a book, a handbook or a notebook that may be required to complete that school day's assignment, as explained with respect to FIG. 18. Lastly, FIG. 21 shows the right page of the embodiment shown on FIG. 20, wherein at least one of the plurality of sections comprises a ruled or blank area for providing notes 2100.

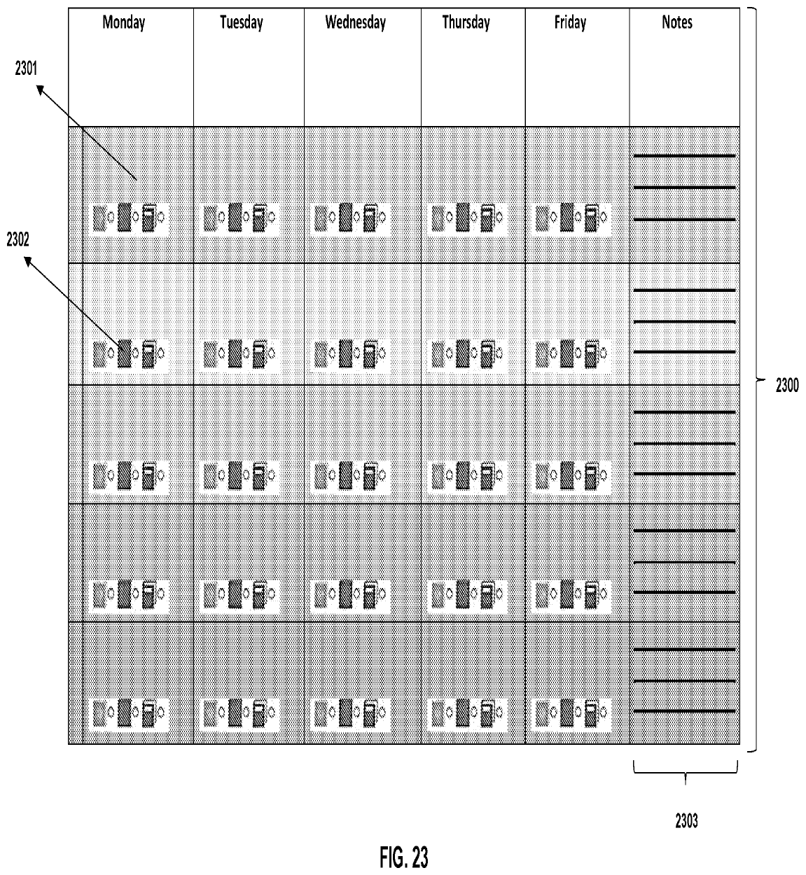

FIG. 23 is a perspective view of a poster calendar 2300 that may be used in association with the organization control article 11 and serves as a visual aid for parents and students. The poster calendar can have any size and comprises a material that is reusable in the sense that it allows the user to write on the poster calendar with a marker and erase what was written later on if necessary. The poster calendar further comprises a plurality of rows and columns, wherein each column corresponds to a particular school day and each row is color-coded and corresponds to a particular subject. As such, each subject is consistently associated with a particular color. Moreover, the point at which a row and column intersect with each other forms an intersection area 2301 that represents the specific school day allotted or dedicated to a particular subject. Furthermore, the intersection area 2301 comprises at least one section having at least one material task identifier 2302 that allows the user to identify the text or materials required to complete that particular school day's assignment, wherein the material task identifier includes, but is not limited to, indicia representing a book, a handbook or a notebook that may be required to complete that school day's assignment, as explained with respect to FIG. 18. Lastly, the poster calendar optionally includes at least one of the columns of the poster calendar includes a ruled or blank area for providing notes 2303 for each particular subject.

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the claims. Therefore, the above description should not be taken as limiting the scope of the invention which is defined by the appended claims

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

What is claimed is:

1. A method for tracking and motivating student behavior through rewards comprising the steps of:
establishing one or more student milestones;
establishing a required number of milestones for giving a student one of a plurality of rewards;
identifying said one or more student milestones by placing milestone indicia on a control article;
identifying said student's activity by placing activity indicia on one or more course articles;
identifying said required number of milestones for a reward by placing reward indicia on said control article;
marking achievement of said one or more student milestones by placing milestone markers over said milestone indicia on said control article every time a milestone is achieved by said student;
giving said student said reward every time said required number of milestones are achieved;
marking said given reward by placing a reward marker over said reward indicia on said control article;
wherein said control article comprises one or more of control sections;
wherein each of said one or more course articles corresponds to said one or more control sections;
wherein said activity indicia indicates which course article corresponds to each control section based on said control indicia;
wherein achieving said required number of milestones entitles said student to one of said plurality of rewards; and
wherein each reward in said plurality of rewards is different from each other.

2. The method of claim 1, wherein said control article is an agenda or poster.

3. The method of claim 1, wherein said milestone indicia comprises text describing a milestone.

4. The method of claim 1, wherein said milestone indicia comprises a number indicating the number of milestones achieved.

5. The method of claim 1, wherein said milestone indicia comprises a drawing.

6. The method of claim 1, wherein said milestone markers and said reward markers are stickers.

7. The method of claim 1, wherein said reward comprises granting said student permission to perform in the classroom an activity of his election, wherein said activity is selected by said student from a predetermined list of activities.

8. The method of claim 1, wherein said course articles are one of the following: notebook, folder, envelopes or stickers.

9. The method of claim 1, wherein tracking academic activity tracking student milestones and rewards related to said milestones.

10. An academic course organizational system comprising:
a control article;
wherein said control article comprises one or more of control sections;
wherein each control section further comprises control indicia;
one or more of academic course articles;
wherein each of said one or more course articles comprises identifying indicia;
wherein each of said one or more course articles corresponds to said one or more control sections; and
wherein said identifying indicia indicates which course article corresponds to each control section based on said control indicia, thus allowing a user to determine which control section to use for each course article.

11. The academic course organizational system of claim 10, wherein said control article is an agenda or a poster.

12. The academic course organizational system of claim 10, wherein said course articles are one of the following: notebook, folder, envelope or sticker.

13. The academic course organizational system of claim 10, wherein at least one section is configured to allow for tracking student milestones and rewards related to said milestones.

14. The academic course organizational system of claim 10, wherein at least one section is configured to allow for tracking student behavior.

15. The academic course organizational system of claim 10, wherein at least one section is configured to allow for tracking tasks related to a course.

16. The academic course organizational system of claim 10, wherein at least one section is configured to allow for providing comments or notes.

17. The academic course organizational system of claim 10, wherein said control indicia and said identifying indicia comprise different colors.

18. The academic course organizational system of claim 10, wherein said control indicia and said identifying indicia comprise different colors.

19. The academic course organizational system of claim 10, wherein said control indicia and said identifying indicia comprise icons representing a book, a handbook, or a notebook.
